(19) United States
(12) Patent Application Publication
(10) Pub. No.: US 2016/0270889 A1
(43) Pub. Date: Sep. 22, 2016

(54) A POLISHER NOZZLE

(71) Applicant: SOCIETE POUR LA CONCEPTION DES APPLICATIONS DES TECHNIQUES ELECTRONIQUES, Merignac (FR)

(72) Inventors: Thierry CASABONNE, Bordeaux (FR); Vianney RUELLAN, Bordeaux (FR); Ulrich SAXER, Forch (CH)

(21) Appl. No.: 15/029,731

(22) PCT Filed: Oct. 10, 2014
(86) PCT No.: PCT/FR2014/052585

§ 371 Date: Apr. 15, 2016

(30) Foreign Application Priority Data
Oct. 15, 2013 (FR) 1360030

(51) Int. Cl. A61C 17/02; A61C 3/025

(52) U.S. Cl. CPC A61C 17/0217; A61C 17/0202; A61C 3/025

(57) ABSTRACT

A polisher nozzle for dental treatment comprises a body extending between a proximal portion for connection to a handpiece and a distal portion. The body has a first channel for delivering a dental polishing powder and a second channel for delivering a fluid. The two channels each open out to at least one respective orifice opening out in the vicinity of the free end of the distal portion wherein the free end of the distal portion forms a spatula extending in line with the distal portion downstream from the orifices. The spatula is arranged at a distance from the orifices in such a manner as to disturb at least in part the flow formed by the dental polishing powder combining with the fluid leaving the orifices.

### BACKGROUND OF THE INVENTION

The present invention relates to the field of polishers for delivering simultaneously a fluid such as water together with a mixture of air and powder, and more particularly the invention relates to a polisher nozzle.

The invention relates in particular to a polisher nozzle for use in dental treatment.

Typically, a polisher mainly comprises a handpiece connected firstly to a compressed air delivery turbine serving to entrain a treatment powder, and secondly, to a fluid feed pump, the handpiece also being provided with an outlet orifice for delivering both the fluid and an air and powder mixture.

The invention relates more particularly, but not exclusively, to the polishers used for treatments in the field of dentistry, in particular those for treating periodontal pockets by delivering a fluid and/or an air/powder mixture between a jaw and a tooth in one or more periodontal pockets. In this particular application, the powder used is a dental powder suitable for cleaning and treating teeth.

The presently available polishers that enable simultaneous delivery of a fluid such as water together with a mixture of air and dental powder are fitted with an outlet nozzle that has two distinct ducts, one for delivering the fluid and the other for delivering the air/powder mixture. Such a nozzle is described in particular in document US 2007/042316.

Document FR 2 962 323 also describes a polisher nozzle including first and second internal channels, the channels being designed to deliver an air/powder mixture and a fluid respectively. That nozzle advantageously makes it possible to deliver a flow (or “spray”) directly at the nozzle outlet, said flow being formed by the fluid combining with the air/powder mixture. Delivery of such a flow is made possible by providing a chamber in the vicinity of the free end of the distal portion of the nozzle, with the first and second internal channels opening out into said chamber so that the fluid and the air/powder mixture combine in the chamber, and then disperse together outside the nozzle via two lateral openings provided for that purpose.

The nozzle described in document FR 2 962 323 offers satisfactory results, in particular because the flow including both the fluid and the air/powder mixture is dispersed effectively through the lateral openings into the zone to be treated (e.g. a periodontal pocket).

However, it is desirable to further improve the effect of dispersing the flow leaving the nozzle so as to optimize the effectiveness of the treatment in the zone concerned.

In addition, the dental powder is generally water soluble. The Applicant has observed that, if the powder is mixed for too long with water in the chamber located in the vicinity of the end of the nozzle, there is a risk that the powder will dissolve to a considerable extent and form a viscous mixture that, in certain circumstances, can obstruct, at least partially, the openings through which the flow (or spray) is to be delivered. That risk of clogging depends in particular on the grain size of the powder used.

There is thus currently a great need for a polisher nozzle that provides performance that is better than that of prior art models, and in particular, that enables the above-identified problems to be mitigated.

### OBJECTS AND SUMMARY OF THE INVENTION

To this end, the present invention provides a polisher nozzle for dental treatment, comprising a body extending between a proximal portion for connection to a handpiece and a distal portion, the body having a first channel for delivering a dental polishing powder and a second channel for delivering a fluid; and

each of the two channels opening out to at least one respective orifice opening out (or being arranged) in the vicinity of the free end of the distal portion;

wherein at least a portion of the free end of the distal portion forms a spatula extending in line with said distal portion downstream from said orifices, the spatula being arranged at a distance from (or spaced apart from) said orifices in such a manner as to disturb at least in part the flow formed by the combination of the dental polishing powder and the fluid leaving said orifices.

By disturbing the passage of outgoing flow (i.e. the flow formed by the combination of the dental polishing powder and the fluid), the spatula entrains dispersion of said outgoing flow in the zone to be treated. This dispersion is advantageous in that the field of dispersion is very broad and makes it possible to cover the zone to be treated in optimal manner. The flows of polishing powder and fluid combine upstream from the spatula (i.e. in the space separating the spatula from the orifices), in such a manner that the powder and the fluid are projected in homogeneous manner in multiple directions.

Moreover, the nozzle in a particular embodiment of the invention is not provided with a chamber for receiving the powder and the fluid, such as for example in the nozzle of document FR 2 962 323. In this embodiment, the orifices of the first and second channels lead directly to the outside of the nozzle, in the vicinity of the distal portion of the nozzle. In this particular embodiment, the fluid and the powder are mixed directly together at the outlets of the orifices in the external space between said orifices and the spatula. Any potential risk of clogging, as explained above, is thus avoided insofar as the fluid and the polishing powder mix only outside the nozzle.

Moreover, given its positioning at the free end of the distal portion, the spatula is advantageous in that it can make it easier for the practitioner to insert the end of the nozzle in the zone that is to be treated. The nozzle of the invention may in particular make it easier to insert the nozzle into a periodontal pocket.

In a particular embodiment, the spatula is substantially parallel to the outgoing flow.

In a particular embodiment, the spatula extends in an axial plane of the distal portion.

The axial plane in which the spatula extends may form a given non-zero angle α with the horizontal axial plane of the distal portion of the nozzle (this horizontal axial plane itself being perpendicular to the vertical axial plane of the proximal portion of the nozzle). By way of example, said given angle α lies in the range 13° and 17° and is preferably 15° (or substantially equal to 15°). Setting the angle α in this way advantageously makes it easier to access certain teeth of the patient, e.g. such as the molars, without requiring excessive turning of the hand by the practitioner. The nozzle and the polisher are thus made more ergonomic.

In a variant, the angle α is zero. The spatula then extends in the horizontal axial plane from the distal portion of the nozzle.

In a particular embodiment, the orifices are directed in such a manner as to direct the outgoing flow at least in part towards an edge of the spatula. In a particular embodiment, the outgoing flow is at least partly directed towards the proximal edge of the spatula. This preferred orientation makes it possible to optimize the effect of dispersion resulting from disturbance of the outgoing flow by the spatula.

In a particular embodiment, the spatula is configured so that said outgoing flow disperses on opposite sides of said spatula. Dispersion is thus optimal.

In a particular embodiment, the first channel opens out in a first central orifice and the second channel opens out in two second orifices located on opposite sides of the first orifice.

In this particular embodiment, the second orifices may be configured to cause the outgoing fluid to converge towards the polishing powder leaving said first orifice. In other words, the second orifices may be configured so that respective flows of fluid leaving said second orifices converge towards the flow of powder (or air/powder mixture) leaving the first orifice.

Again, in this particular embodiment, the second orifices may be slot-shaped and the first orifice may be of substantially circular shape.

The circular shape of the first orifice makes it possible to obtain a fluid/powder outgoing flow that is particularly homogeneous, while the slot-shaped second orifices make it possible to deliver the fluid in such a manner that it channels the powder flow by surrounding the powder flow at least partially, so as to improve the effect of dispersion on the spatula.

In a particular embodiment, each orifice of the first and second channels opens out to the outside of the nozzle in the vicinity of the free end of said distal portion of the nozzle so that said combining of the dental polishing powder and of the outgoing fluid leaving said orifices takes place outside said nozzle.

In a particular embodiment, the spatula presents a tapered shape in order to make it easier to insert said nozzle into a zone to be treated.

In a particular embodiment, the nozzle further includes a fastener mechanism in the vicinity of the free end of the distal portion, which fastener mechanism is configured to fasten the spatula in the working position, said fastener mechanism allowing said spatula to be detached for its potential replacement.

In a particular embodiment, the outgoing flow that results from the polishing powder combining with the fluid is substantially parallel to the longitudinal axis of the distal portion of the nozzle.

In a particular embodiment, the fluid is a liquid, e.g. such as water.

The present invention further provides a polisher comprising a handpiece including a first channel for feeding polishing powder and a second channel for feeding fluid, the polisher being characterized in that it further includes a nozzle as defined above, the proximal portion of the nozzle being connected to the handpiece, said first channel for feeding polishing powder co-operating with the first channel in the nozzle, and said second channel for feeding fluid co-operating with the second channel in the nozzle.

### BRIEF DESCRIPTION OF THE DRAWINGS

Other characteristics and advantages of the present invention appear from the following description, with reference to the accompanying drawings showing embodiments that are in no way limiting, in which:

FIG. 1 is a general perspective view of a polisher nozzle constituting a particular embodiment, together with a portion of a handpiece connected to the nozzle;

FIG. 2 is a perspective view in section on II of the nozzle and the portion of a handpiece of FIG. 1;

FIG. 3 is a plan view of the FIG. 1 nozzle;

FIG. 4 is a side view of the FIG. 1 nozzle;

FIG. 5 is a view of a detail in perspective and in section on V of FIG. 2 and of the free end of the distal portion of the FIG. 1 nozzle;

FIG. 6 is a perspective view of the distal portion of the FIG. 1 nozzle;

FIG. 7 is a detail view from above of the free end of the distal portion of the FIG. 1 nozzle; and

FIG. 8 is a front view of the FIG. 1 nozzle.

### DETAILED DESCRIPTION OF EMBODIMENTS OF THE INVENTION

The present invention relates to the field of polishers for delivering simultaneously a fluid (such as water) and a mixture of air and powder, and more particularly it relates to a polisher nozzle.

Below, this document describes implementations of the invention relating to a polisher in the field of dentistry, and more particularly, to a polisher adapted to dental treatment such as treating periodontal pockets, for example. However, it should be understood that the invention relates more generally to a polisher nozzle that is suitable for delivering a flow comprising a fluid and powder (e.g. dental powder or polishing powder) into a zone to be treated.

Furthermore, in the embodiments described below the fluid delivered by the nozzle is a fluid that is preferably a liquid, such as water for example. However, it should be understood that any other fluid suitable for transporting and channeling a powder may be used within the ambit of the invention. As an alternative to water, it is thus possible to use air or any gas or gas mixture as a fluid in the nozzle of the invention.

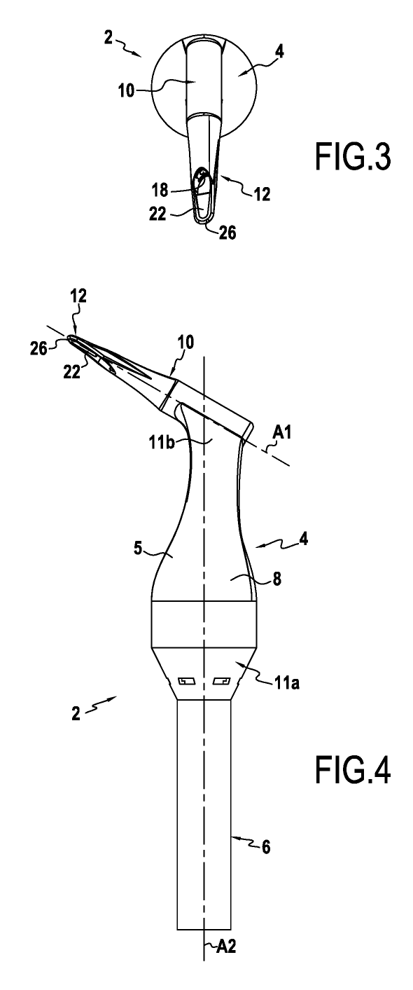

FIGS. 1 to 8 show a polisher 2 and a polisher nozzle 4 constituting a particular embodiment of the invention.

A nozzle 4 is made up of a body 5 that extends between a proximal portion 8 for coupling mechanically with a handpiece 6 for feeding the air/powder mixture and fluid as explained below, and a distal portion 10 with the air/powder mixture and the fluid being delivered from its end. For the air/powder mixture, it is possible to use a gas (or gas mixtures) other than air.

In this example, the proximal portion 8 has a free end 11a including a connector provided with a gasket in order to enable a leaktight connection to be made between the handpiece 6 (only the distal end of which is shown in the figures) and the nozzle 4. The opposite end 11b of the proximal portion 8 is extended by the distal portion 10 of nozzle 4.

In this example, the junction between the proximal portion 8 and the distal portion 10 forms a bend to make it easier for the practitioner to point the nozzle appropriately by manipulating the handpiece 6.

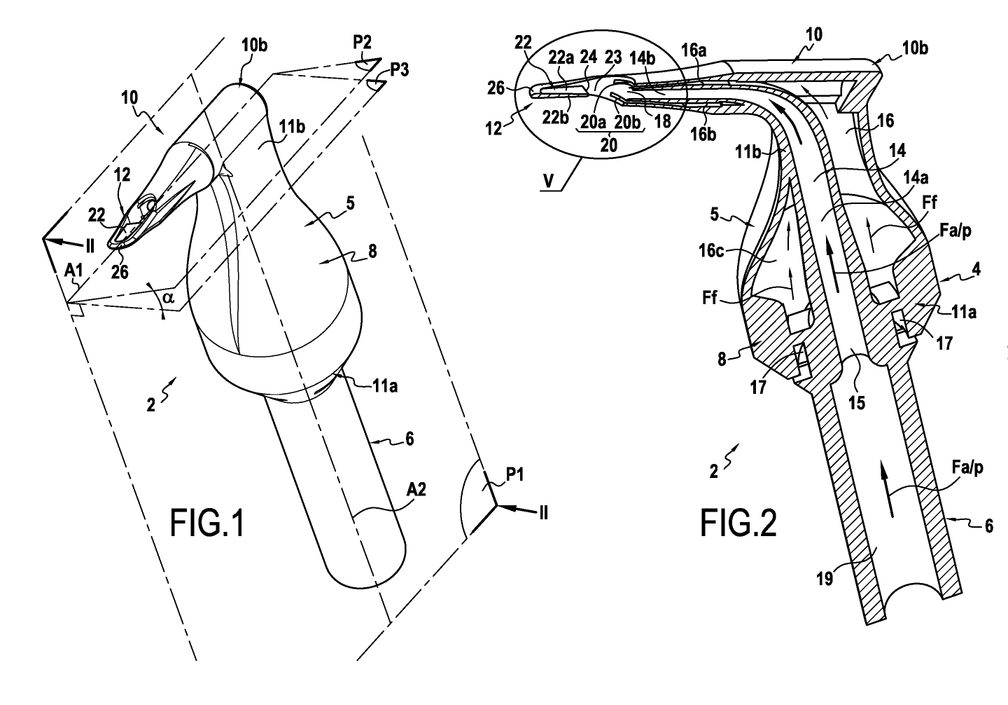

The nozzle 4 has first and second internal channels 14 and 16, each extending inside the body 5 from the free end 11 a of the proximal portion 8 to the free end 12 of the distal portion 10 (FIG. 2).

More precisely, in the example under consideration, the first internal channel 14 is formed in the center of the proximal and distal portions 8, 10. This first channel 14 opens out at the inlet of the nozzle into an inlet orifice 15 that is suitable for receiving a flow Fa/p of air and powder mixture delivered by the handpiece 6. In addition, the first channel 14 opens out at the outlet of the nozzle into an outlet orifice 18, itself opening out (or being arranged) in the vicinity of the free end 12 of the distal portion 10.

The second internal channel 16 opens out at the inlet of the nozzle 4 into an inlet orifice 17 and at the outlet of the nozzle into two outlet orifices 20a and 20b, collectively given the reference 20 (FIG. 2), these outlet orifices 20 themselves opening out (or being arranged) in the vicinity of the free end 12 of the distal portion 10. This second internal channel 16 is for receiving a flow Ff of fluid coming from the handpiece 6.

It should be noted that the number and the positioning of the respective outlet orifices for each of the two internal channels 14 and 16 may be adapted as needed. In particular, it is possible to envisage forming a single outlet orifice 20 for the second internal channel 16, even though the arrangement with two orifices 20 as described above is preferred.

Each of the two internal channels should open out into at least one respective outlet orifice in the vicinity of the free end of the distal portion of the nozzle.

In the example shown in the figures, the second internal channel 16 presents a first annular portion 16c extending from the free end 11a of the proximal portion 8 and forming a duct around a first portion 14a of the first internal channel 14 in the proximal portion 8. In this example, the first annular portion 16c presents a shape that is initially cylindrical and then becomes frustoconical.

Again in this example, at the end of said first annular portion 16c, the second channel 16 splits into two internal ducts 16a and 16b that pass through the distal portion 10 of the nozzle to open out into the orifices of the orifices 20a and 20b respectively. However, the person skilled in the art could envisage other arrangements of the internal channels of the nozzle within the ambit of the invention.

In this example, the internal ducts 16a and 16b collectively form the distal portion of the second internal channel 16 opening out in the vicinity of the free end 12 of the distal portion 10.

In the example under consideration, both internal ducts 16a and 16b extend along and parallel to the distal portion 14b of the first internal channel 14, this portion 14b itself extending along the distal portion 10 in order to open out in the outlet orifice 18. In this example, both internal ducts 16a and 16b are arranged on opposite sides of the distal portion 14b of the first internal channel 14.

In this example, the nozzle 4 is mounted on the handpiece 6, with only a portion of its distal end being shown in the figures. By way of example, the handpiece 6 is connected with an interchangeable tank (not shown) containing dental powder. The handpiece 6 may also be connected to a compressor (not shown) for sending a flow under pressure to the handpiece. Finally, a pump may be connected to the handpiece 6 in order to supply it with fluid, preferably a liquid fluid.

The first internal channel 14 of the nozzle cooperates at the distal end 11a with an internal duct 19 of the handpiece 6 delivering the flow Fa/p of air/powder mixture. In addition, the second internal channel 16 of the nozzle cooperates at the distal end 11a with an internal duct (not shown) of the handpiece 6 delivering the flow Fa/p of air/powder mixture.

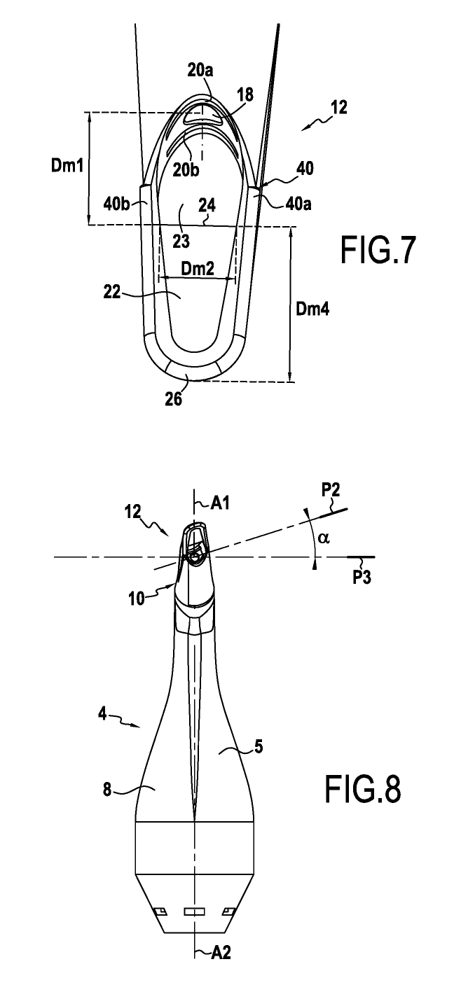

In the present invention, at least one portion of the free end 12 of the distal portion 10 of the nozzle 4 forms a spatula (or “tongue”, or “tab”) 22 extending in line with the distal portion 10 downstream from the outlet orifices 18 and 20 (FIG. 7).

As shown in FIGS. 1 to 8, the spatula 22 is mounted in this example at the free end 12 of the distal portion 10, said spatula being fixed securely to the remainder of the nozzle. In this example, the spatula is fastened by means of a fastener mechanism 40 comprising two arms 40a and 40b.

In this example, the spatula 22 extends in an axial plane P2 of the distal portion 10, this plane P2 forming a predetermined angle α about the longitudinal axis A1 of the distal portion relative to the horizontal axial plane P3 of the distal portion 10 (FIG. 1). This angle α is described in more detail below. The horizontal axial plane P3 shown in FIG. 1 is perpendicular to the vertical axial plane P1 of the proximal portion 8.

The spatula 22 has two free faces 22a and 22b that are opposite each other. These top and bottom faces 22a, 22b may come directly into contact with the patient's mouth, when treating a periodontal pocket for example.

In accordance with the present invention, the spatula 22 is arranged at a distance from (or spaced apart from) the outlet orifices 18 and 20 in such a manner as to disturb at least in part the outgoing flow (or spray) Fs formed by the dental polishing powder combined with the fluid leaving the orifices 18 and 20. This combination entrains the powder and fluid mixture. To do this, the powder and fluid outlet orifices are preferably relatively close to each other.

By way of example, the flow Fs delivered at the nozzle outlet takes the form of a spray or jet under pressure that comprises both the fluid and the powder.

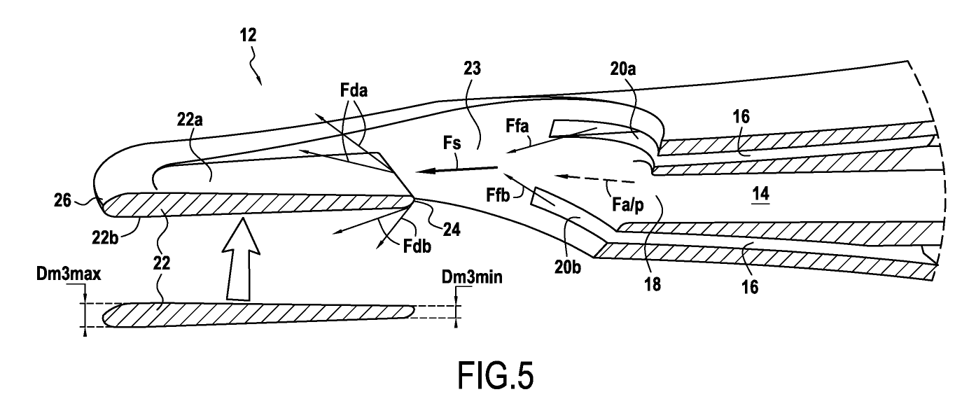

In this example, the spatula 22 is arranged in the passage of the outgoing flow Fs delivered by the nozzle, this flow Fs being formed firstly by the combination of the flow Fa/p of air with the powder leaving the orifice 18, and secondly by the flows of fluid Ffa, Ffb (collectively having the reference Ff) leaving the respective outlet orifices 20a and 20b (FIG. 5). The spatula 22 does not block the passage of the outgoing flow Fs completely, but it does disturb the passage of the flow in the vicinity of the free end 12 of the distal portion 10. More particularly, the function of the spatula 22 is to disperse the flow Fs delivered at the nozzle outlet.

In this embodiment, the spatula 22 is arranged parallel (or substantially parallel) to the direction of the outgoing flow Fs.

Again in this embodiment, an opening 23 passing right through the nozzle 4 in the vicinity of its free end 12 is arranged so as to form an empty space between the outlet orifices and the spatula 22 (FIG. 7). A gap Dm1 is thus provided between the outlet orifices and the spatula 22 (more precisely with the proximal edge 24 of the spatula 22 facing the outlet orifices 18 and 20). In this example, the gap Dm1 is defined between the orifice 18 and the nearest point of the proximal edge 24 of the spatula 22.

This gap Dm1 is selected so that the flows Ff and Fa/p combine at least in part before reaching the proximal edge 24 of the spatula 22, the combination of the flows Ff and Fa/p thus forming the outgoing flow Fs in which the polishing powder and the fluid are mixed.

As indicated above, the spatula 22 gives rise to dispersion of the outgoing flow Fs formed by the combination of flows Ff and Fa/p upstream from the spatula 22 in the space 23. This dispersion is advantageous in that it takes place over a very broad field and makes it possible to cover the zone to be treated in optimal manner. The flows Ff and Fa/p combine before the dispersion occurs, in such a manner that the powder and fluid mixture is sprayed in homogeneous manner in multiple directions.

In the particular embodiment under consideration, the first channel 14 and the second channel 16 both open out directly to the outside of the nozzle 4 via respective outlet orifices in the vicinity of the distal portion 10. Polishing powder and fluid leaving the outlet orifices 18 and 20 are thus mixed outside the nozzle 4 in this example.

The nozzle in this particular embodiment of the invention is thus not provided with a chamber (or with any spaces inside the nozzle) that is designed to receive the powder and the fluid, such as for example in the nozzle of document FR 2 962 323. In the embodiment under consideration, the fluid and the powder mix together outside the nozzle, and more particularly in this example, they mix together directly at the outlets of the orifices in the outside space separating said orifices from the spatula. Any potential risks of clogging are thus removed, as explained above.

However, variant embodiments may be considered in which the fluid and the polishing powder are mixed together in a zone inside the nozzle (e.g. in the vicinity of the distal portion 10 of the nozzle 4) so that the outgoing flow is already a mixture of fluid and polishing powder.

Moreover, given its positioning at the free end 12 of the distal portion 10, the spatula is advantageous in that it makes it easier for the person skilled in the art to insert the end of the nozzle into the zone to be treated. By way of example, the nozzle of the invention may make it easier to insert the nozzle into a periodontal pocket.

The geometry of the spatula, and in particular the geometry of the distal edge 26 of the spatula 22 remote from the proximal edge 24, may be configured in order to further facilitate access to a zone to be treated, such as a periodontal pocket. By way of example, the spatula may present a tapered shape.

In this example, the spatula 22 has thickness Dm3 that is small compared to its other dimensions. In the example under consideration, the thickness Dm3 lies in the range Dm3min=0.1 millimeters (mm) to Dm3max=0.35 mm (FIG. 5). Again in this example, Dm1=2.15 mm, Dm2=1.35 mm, and Dm4=3 mm (FIG. 7). Other values for the above dimensions are possible, however.

In addition, the shape and the dimensions of the spatula 22 can be adapted by the person skilled in the art depending on requirements.

In this example, the spatula 22 is made from a metal (or a metal alloy), other materials being suitable for being used if necessary depending on requirements. The spatula 22 may be rigid or it may possibly present a certain degree of flexibility depending on the needs of the practitioner.

In the embodiment described here, the disturbance, or dispersion, of the flow Fs is caused by the outgoing flow Fs coming into contact with the spatula 22, and more particularly coming into contact with its proximal edge 24. In this example, the proximal edge 24 forms a stop having its profile in cross section that may be adapted depending on the way in which it is sought to disperse the flow Fs at the nozzle outlet.

In this particular example, the spatula 22 and the outlet orifices are configured so that the outgoing flow Fs comprising the powder and the fluid disperse on either side of the spatula 22. The collision of the flow Fs against the proximal edge 24 gives rise to the formation of dispersed flows Fda, Fdb respectively beside top and bottom faces 22a, 22b of the spatula 22.

In the configuration of the spatula 22 and of the outlet orifices, it is possible to give precedence to the dispersion either of Fda, or of Fdb, so as to spray the powder/fluid mixture in a particular direction on a priority basis.

In a variant embodiment, the nozzle (and more particularly the spatula and the orifices) is configured so that the outgoing flow Fs essentially collides with one of the faces of the spatula 22, said face giving rise to dispersion of the flow.

In the embodiment under consideration, the outlet orifices of the nozzle of the invention are configured so as to make the outgoing fluid converge on the flow of powder. In preferred manner, this convergence is such that the outgoing flow Fs formed by the combination of the fluid with the polishing powder is directed towards the (facing) proximal edge of the spatula.

Thus, in the embodiment in FIGS. 1 to 8, the orifices 20a and 20b are oriented in such a manner as to cause the respective flows Ffa and Ffb to converge towards the flow Fa/p leaving the orifice 18. This convergence makes it possible to unite the three flows Ffa, Ffb and Fa/p so as to form the outgoing flow Fs before it comes into contact with the spatula 22, and more particularly with the proximal edge 24 in this example.

In the particular example under consideration, the free end 12 of the distal portion 10 includes two orifices 20 for delivering the flow Ff of fluid. The disposition of the orifices 20a and 20b on opposite sides of the orifice 18 advantageously makes it possible to channel the flow Fa/p of the air/powder mixture in order to concentrate the outgoing flow Fs towards the spatula 22, and more particularly towards the proximal edge 24 of the spatula 22 in this example, thus further improving dispersion of the flow Fs.

Alternatively, it is nevertheless possible to cause the flow Fs to converge towards one of the faces of the spatula 22.

The effect of channeling the flow Fa/p is further improved when the orifices 20 delivering the fluid are slots as in the example under consideration.

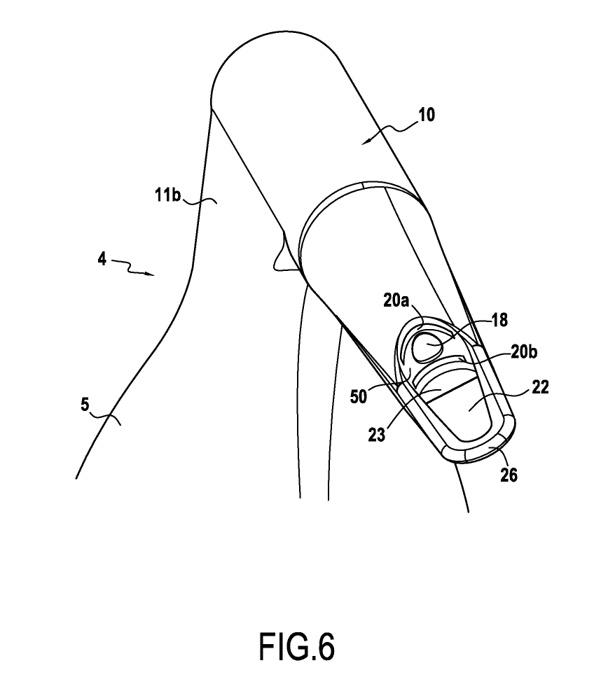

More precisely, as shown for example in FIG. 6, the free end 12 of the distal portion 10 comprises a surface 50 onto which the orifices 18, 20a, and 20b open out, said surface 50 facing the proximal edge 24 of the spatula 22. The surface 50, the arms 40, and the proximal edge 24 form the outlines of the opening 23.

The orifices 20a and 20b are in the shape of slots arranged in parallel with each other on opposite sides of the central orifice 18, said central orifice presenting a substantially circular shape. In this example, the slots 20a and 20b extend beyond the orifice 18 on the surface 50 (the slots being longer than the diameter of the central orifice 18). This particular configuration makes it possible to envelop the flow Fa/p with the flows Ffa and Ffb that are located on opposite sides and thus to cause an outgoing flow Fs to converge towards the spatula 22 for optimal dispersion.

In preferred manner, the surface 50 is curved in concave manner so as to increase the above-mentioned enveloping effect and thus so as to optimize even further the channeling effect of the flows Ff on the flow Fa/p, as in the example under consideration.

By way of example, the flow rates of the flows Ffa, Ffb, and Fa/p are configured in the following manner, although other configurations are possible depending on requirements and on the geometry of the nozzle:

flow rate Ffa=flow rate Ffb=15 milliliters/minute (mL/min), and in any event≧10 mL/min; and

the flow rate Fa/p is such that the air flow rate is greater than or equal to 3 liters/minute (L/min) and the powder consumption is greater than 2 grams/minute (g/min).

In addition, the circular shape of the orifice 18 advantageously makes it possible to obtain an outgoing flow Fs that is particularly homogeneous before being dispersed by the spatula.

In the example under consideration, the spatula 22 is plane, although a different profile (e.g. more or less curved) is possible within the ambit of the invention.

The shape, number, dimensions, and arrangement of the orifices delivering the flows under consideration may be adapted by the person skilled in the art depending on requirements.

In the embodiment described, the outgoing flow Fs is parallel (or substantially parallel) to the longitudinal axis A1 of the distal portion 10 of the nozzle.

In a particular implementation, the predetermined angle α defined by the planes P2 and P3 lies in the range 13° to 17°, and is preferably 15°. The existence of this angle α makes it possible to make the nozzle more ergonomic in certain applications. By way of example, the sometimes-difficult access by the practitioner to a patient's molars is facilitated by the slope a of the spatula 22 around the longitudinal axis A1.

However, it should be understood that it is not essential for the spatula 22 to be inclined about the longitudinal axis A1 relative to the horizontal axial plane P3 of the distal portion 10. In a particular example, the spatula 22 extends in the plane P3 itself (in other words, the plane P2 coincides with the horizontal axial plane A3 of the distal portion 10 so that α=0).

It should also be observed that the angle between the longitudinal axis A1 of the distal portion 10 and the longitudinal axis A2 of the proximal portion 8 may be adapted depending on requirements, in particular so as to make the nozzle as ergonomic as possible as a function of the practitioners and the uses under consideration.

In addition, as mentioned above, in this example the nozzle 4 includes a fastener mechanism 40 located in the vicinity of the free end 12 of the distal portion 10 and allowing the spatula 22 to be fastened in the working position on the remainder of the nozzle. In a particular embodiment, this fastener mechanism 40 selectively allows detachment of the spatula 22 for its possible replacement. It is thus possible for a practitioner to change the spatula if it presents increased wear or so as to choose a spatula that is different (in terms of shape, materials . . . ) and that is better adapted to a particular need.

In summary, the spatula of the invention makes it possible to disperse effectively the outgoing flow from the nozzle, said flow resulting from a combination of at least one flow of polishing powder and at least one flow of fluid. The nozzle of the invention further makes it possible to avoid the risks of clogging inherent to certain nozzles of the prior art.

Furthermore, the spatula may advantageously be used to facilitate insertion of the nozzle into a treatment zone such as a dental zone of a patient (e.g. periodontal pockets).

It should be understood that the above-described embodiments and alternatives only constitute nonlimiting embodiments of the invention. In particular, the person skilled in the art may envisage any combination of the above-described variants and embodiments in order to meet any particular requirement.

1-14. (canceled)

15. A polisher nozzle for dental treatment, comprising a body extending between a proximal portion for connection to a handpiece and a distal portion, the body having a first channel for delivering a dental polishing powder and a second channel for delivering a fluid; and
each of the two channels opening out to at least one respective orifice opening out in the vicinity of the free end of the distal portion;
the nozzle being wherein at least a portion of the free end of the distal portion forms a spatula extending in line with said distal portion downstream from said orifices, the spatula being arranged at a distance from said orifices in such a manner as to disturb at least in part the flow formed by the combination of the dental polishing powder and the fluid leaving said orifices.

16. A nozzle according to claim 15, wherein the spatula is substantially parallel to the outgoing flow.

17. A nozzle according to claim 15, wherein the spatula extends in an axial plane of the distal portion.

18. A nozzle according to claim 17, the plane in which the spatula extends forms an angle with the horizontal axial plane that is substantially equal to 15° from the distal portion.

19. A nozzle according to claim 15, wherein said orifices are oriented in such a manner as to direct the outgoing flow at least in part towards an edge of the spatula.

20. A nozzle according to claim 15, wherein said spatula is configured so that said outgoing flow disperses on opposite sides of said spatula.

21. A nozzle according to claim 15, wherein the first channel opens out in a first central orifice and the second channel opens out in two second orifices located on opposite sides of said first orifice.

22. A nozzle according to claim 21, wherein the second orifices are configured to cause the outgoing fluid to converge towards the polishing powder leaving said first orifice.

23. A nozzle according to claim 15, wherein each orifice of the first and second channels opens out to the outside of the nozzle in the vicinity of the free end of said distal portion of the nozzle so that said combining of the dental polishing powder and of the outgoing fluid leaving said orifices takes place outside said nozzle.

24. A nozzle according to claim 15, the spatula presenting a tapered shape in order to make it easier to insert said nozzle into a zone to be treated.

25. A nozzle according to claim 15, further including a fastener mechanism in the vicinity of the free end of the distal portion, which fastener mechanism is configured to fasten the spatula in the working position, said fastener mechanism allowing said spatula to be detached for its potential replacement.

26. A nozzle according to claim 15, wherein said flow is substantially parallel to the longitudinal axis of the distal portion of the nozzle.

27. A nozzle according to claim 15, wherein said fluid is a liquid.

28. A polisher comprising a handpiece including a first channel for feeding polishing powder and a second channel for feeding fluid, the polisher being wherein it further includes a nozzle according to claim 15, the proximal portion of the nozzle being connected to the handpiece, said first channel for feeding polishing powder co-operating with the first channel in the nozzle, and said second channel for feeding fluid co-operating with the second channel in the nozzle.
